(19) United States
(12) Patent Application Publication
(10) Pub. No.: US 2011/0113886 A1
(43) Pub. Date: May 19, 2011

(54) APPARATUS FOR COUPLING AN ULTRASOUND PROBE TO AN OBJECT

(75) Inventors: Naiara Elejalde, Begues (ES); Malcolm John Watson, Glasgow (GB); George A. Corner, Dundee (GB)

(73) Assignee: Greater Glasgow Health Board, Glasgow (GB)

(21) Appl. No.: 12/443,660

(22) PCT Filed: Oct. 1, 2007
(86) PCT No.: PCT/GB07/03712

§ 371 Date: Dec. 21, 2010

(30) Foreign Application Priority Data
Sep. 30, 2006 (GB) 0619322.1

(51) Int. Cl. G01N 29/28; C08L 29/04

(52) U.S. Cl. 73/644; 524/503

(57) ABSTRACT

Improved coupling apparatus (10) for coupling an ultrasound probe (24) to an object (26) is described. The apparatus (10) is particularly suitable for use within medical devices. The coupling apparatus (10) comprising first (14) and second (18) deformable coupler located on separate sides of an intermediate layer (16). Employing the first coupler (14) allows the apparatus (10) to be coupled to the probe (24) while the second coupler (18) provides a means for coupling the apparatus (10) to the object (26). The intermediate layer (16) acoustically connects the first (14) and second couplers (18) while providing structural strength for the apparatus (10). Optionally a sheath or cover (157) may be incorporated within the coupling apparatus (141) so as to improve the hygiene and sterile nature of the device.

This invention relates to an apparatus for coupling an ultrasound probe to an object. The apparatus is suitable for use in medical devices and other related fields although it is not restricted to use in those fields.

Ultrasound probes are well known and well used in medicine. For example, ultrasound imaging is used to provide expectant mothers with images of the foetus, to measure the blood flow in veins and arteries and when a medical practitioner wishes to inspect an internal cavity of a patient.

In most cases, the apparatus and techniques are very similar to those shown in FIGS. 1 and 2. FIG. 1 shows a system 1 comprising an ultrasound probe 3, having a probe head 5 which contains an ultrasound transducer 10 acoustically coupled to the head 5. Outside the probe a gel 7 is applied to the outer surface of the head 5 or to an object 9 to provide a coupling or contact between the probe head 5 and the object 9.

The gel, typically an aqueous gel, is applied either to the surface of the object 9 or to the probe head 5 in order to ensure effective acoustic coupling between the probe head 5 and the surface of the object 9. The gel is therefore required to provide a constant contact between the head 5 and the surface 9.

It is often the case that the probe 5 will be moved around over a significant area across the object 9 in order to obtain an image. Consequently, a large amount of gel is smeared across the surface of the object 9 which, in the case of a human, may be the abdomen, arm, leg or the like; this is unpleasant, messy and time consuming. In addition, the application of the gel is far from an exact science. It is often the case that the gel must be reapplied in order to obtain a good ultrasound signal.

FIG. 2 shows a second example of the current use of an ultrasound probe. In this case, the system 11 shows probe 13 with a head 15 and gel 17 positioned between the probe head 15 and the object 19 which is a surface in a body cavity 21. In order to keep the ultrasound probe clean it is necessary to retain the probe within a sheath 23. It is common for such sheaths to interfere with the ultrasound signal because they are not acoustically matched to the probe or gel. This, in turn, affects the quality of the image produced by the ultrasound probe.

Single layer gel pads are known to be used as coupling pads. However, these pads are prone to allow air into the path of the ultrasound signal which causes a degradation of the signal and hence the image.

It is therefore an object of an aspect of the present invention to provide a coupling apparatus for coupling an ultrasound probe to an object that obviates, or at least mitigates, one or more of the above described problems experienced by the coupling apparatus known in the art.

### SUMMARY OF INVENTION

In accordance with a first aspect of the invention there is provided a coupling apparatus for coupling an ultrasound probe to an object, the coupling apparatus comprising:

a first coupler connectable to the probe;
a second coupler connectable to the object; and
an intermediate layer for acoustically connecting the first coupler and the second coupler, the intermediate layer being further adapted to provide structural strength to the apparatus,
wherein, the first coupler and the second coupler are adapted for direct acoustic coupling with the respective probe and object.

Preferably, the first coupler and the second coupler are made of a pliable material such that when in contact with the probe and/or object, the respective first coupler and second coupler deform to fit the shape of the probe and object, respectively.

Preferably, the first coupler and the second coupler exude an acoustic coupling liquid when in operative contact with the respective probe and object.

Preferably, the first coupler is shaped to accommodate the probe.

Preferably, the first coupler is made from a material that undergoes syneresis.

Preferably, the first coupler is semi-solid.

Preferably, the first coupler is a gel.

Preferably, the first coupler is a hydro-gel.

Preferably, the first coupler is a polyvinyl alcohol hydro-gel.

Preferably, the first coupler has a composition with less than six weight percentage of polyvinyl alcohol in water.

Preferably, the second coupler is made from a material that undergoes syneresis.

Preferably, the second coupler is a gel.

Preferably, the second coupler is a hydro-gel.

Preferably, the second coupler is a polyvinyl alcohol hydro-gel.

Preferably, the second coupler has a composition of less than six weight percentage polyvinyl alcohol.

Preferably, the intermediate layer has a similar, or identical, acoustic impedance to the first coupler and the second coupler.

Preferably, the intermediate layer has a higher density than the first coupler or the second coupler.

Preferably, the intermediate layer is a gel.

Preferably, the intermediate layer is a hydro-gel.

Preferably, the intermediate layer is a polyvinyl alcohol hydro-gel.

Preferably, the intermediate layer is a polyvinyl alcohol hydro-gel having a percentage composition of polyvinyl alcohol greater than six weight percentage.

Preferably, the intermediate layer is acoustically coupled to the first coupler and the second coupler.

Preferably, the acoustic coupling is achieved via a junction layer.

Preferably, the junction layer is defined by a discrete layer.

Optionally, the junction layer is defined by a transition layer of varying density.

Optionally, the transition layer is characterised by an increased density towards the intermediate layer.

Preferably, the coupler is formed in a single piece.

Optionally, the coupler is formed in three discrete layers.

Optionally, the discrete layers are bonded together.

Optionally, the discrete layers are bonded together using a heating and cooling cycle.

Preferably, the apparatus of the present invention is provided with a sterile cover for use in-vivo.

The cover is used to prevent the probe being contaminated, particularly when used in vivo.

Preferably, the cover is a sheath.

Preferably, the cover is integrally formed with the apparatus of the present invention.

Preferably, the cover is integrally formed with the intermediate layer of the present invention.

Optionally, the cover is connectable to the apparatus of the present invention.

Optionally, the cover is connectable by means of a channel.

Preferably, the channel is in the intermediate layer.

Preferably, the apparatus of the present invention further comprises a frame adapted to support the cover.

In accordance with a second aspect of the present invention there is provided a method for making a coupling apparatus for coupling an ultrasound probe to an object, the method comprising the steps of:
1) applying a heating and cooling cycle to a first mixture in order to form a first hydro-gel of a first density;
2) adding a second mixture to the first formed hydro-gel and applying a heating and cooling cycle to the second mixture so as to form a second hydro-gel having a second density, wherein the second density is higher than the first density; and
3) adding a third mixture to the second hydro-gel and applying a heating and cooling cycle to form a third hydro-gel of a third density, wherein the third density is lower than the second density.

Following the above method results in the formation of a bonded structure comprising three layers of lower and higher density hydro-gels.

Most preferably the third density is selected so as to be equal to the first density.

Preferably the first hydro-gel is a polyvinyl alcohol hydro-gel. Preferably the first hydro-gel has a composition of less than six weight percentage polyvinyl alcohol in water.

Preferably the third hydro-gel is a polyvinyl alcohol hydro-gel. Preferably the third hydro-gel has a composition of less than six weight percentage polyvinyl alcohol in water.

Preferably the second hydro-gel is a polyvinyl alcohol hydro-gel. Preferably the second hydro-gel has a composition of greater than six weight percentage polyvinyl alcohol in water.

In accordance with a third aspect of the present invention there is provided a method for making a coupling apparatus for coupling an ultrasound probe to an object, the method comprising the steps of:
1) applying a heating and cooling cycle to a first mixture in order to form a intermediate hydro-gel layer having a first density;
2) adding a second mixture to a first side of the intermediate hydro-gel layer and applying a heating and cooling cycle to the second mixture so as to form a first hydro-gel layer having a lower density than the intermediate hydro-gel layer; and
3) adding a third mixture to a second side of the intermediate hydro-gel layer and applying a heating and cooling cycle to third mixture so as to form a second hydro-gel layer having a lower density than the intermediate hydro-gel layer.

Optionally the second and third steps are carried out simultaneously.

### BRIEF DESCRIPTION OF DRAWINGS

Aspects and advantages of the present invention will become apparent upon reading the following detailed description and upon reference to the following Figures in which:

FIG. 1 is an illustration of a prior art ultrasound probe arrangement in use;

FIG. 2 is an illustration of another prior art probe arrangement in use;

FIGS. 3A and 3B show a first embodiment of the coupling apparatus in accordance with an aspect of the present invention;

FIG. 4 is an illustration of a second embodiment of the coupling apparatus in accordance with an aspect of the present invention;

FIG. 5 is an illustration of a third embodiment of the coupling apparatus in accordance with an aspect of the present invention;

FIG. 6 is a graph showing the variation in concentration of a polyvinyl alcohol hydro-gel in the example of the present invention shown in FIG. 4;

FIG. 7 is an illustration of a further embodiment of the coupling apparatus in accordance with an aspect of the present invention;

FIG. 8 is an illustration of a further embodiment of the coupling apparatus in accordance with an aspect of the present invention;

FIG. 9 is an illustration of a further embodiment of the coupling apparatus in accordance with an aspect of the present invention;

FIG. 10 is an illustration of a further embodiment of the coupling apparatus in accordance with an aspect of the present invention incorporating a frame and sheath; and

FIG. 11A is a side view of another embodiment of the coupling apparatus in accordance with an aspect of the present invention incorporating a frame and sheath, FIG. 11B is a cross sectional view along lines A-A′ of FIG. 11A and FIG. 11C is a cross sectional view of part of the illustration of FIG. 11A, in order to show the manner in which the sheath is embedded into the intermediate layer.

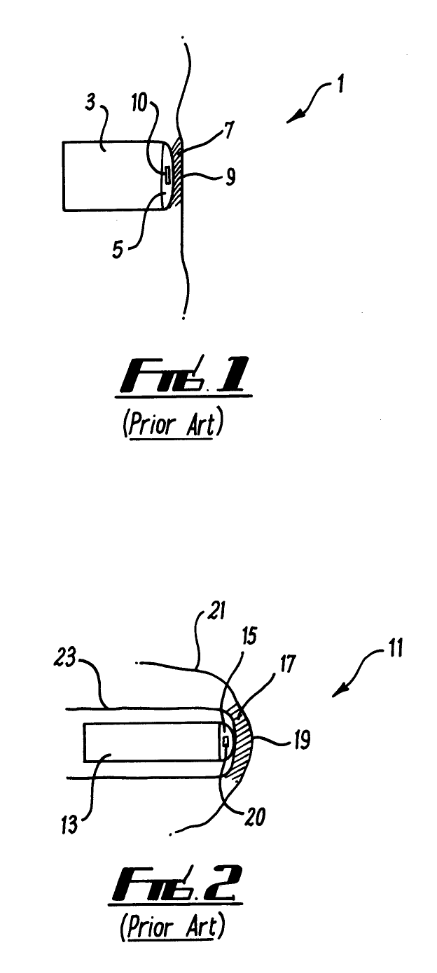

### SPECIFIC DESCRIPTION

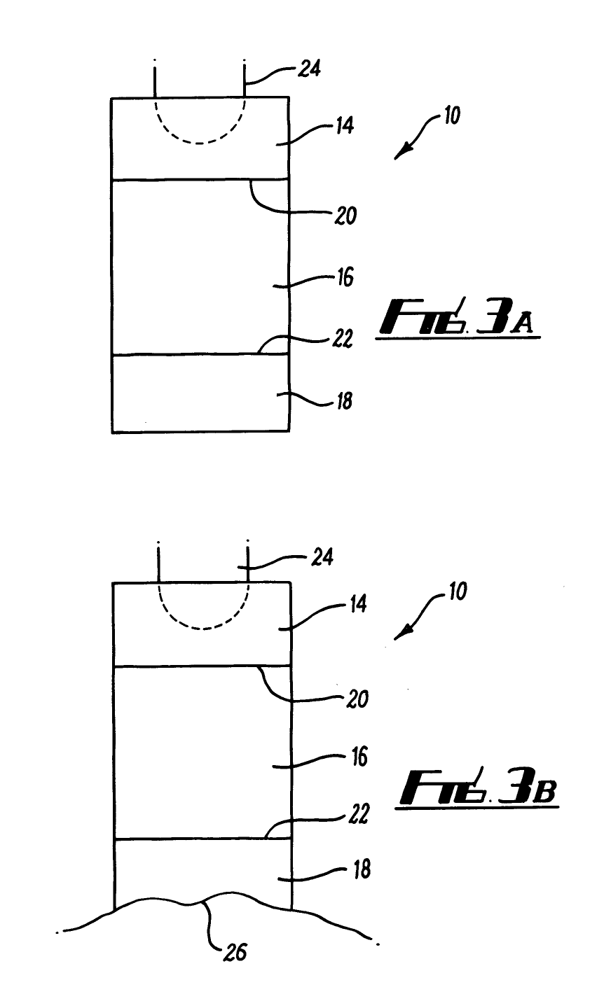

FIGS. 3A and 3B illustrate a first embodiment of the invention 10 having a first coupler 14 an intermediate layer 16 and a second coupler 18. Junction layers 20 and 22 illustrate the position at which the layers are joined.

In this example of the present invention, the first and second couplers 14 and 18 provide a means for directly coupling an ultrasound probe to the apparatus 10 and the apparatus to a body without requiring the application of a coupling gel to the body 26 or the probe 24. In this example the direct coupling is provided by selecting a pliable material of the first 14 and/or second coupler 18 such that the material deforms around the probe 24 and/or body 26. The coupler therefore fits around or conforms to the shape of the probe 24 and/or body 26 to provide good acoustic coupling. In this example, the probe 24 is pressed into the first coupler 14, and the second coupler 18 is pressed against the body 26.

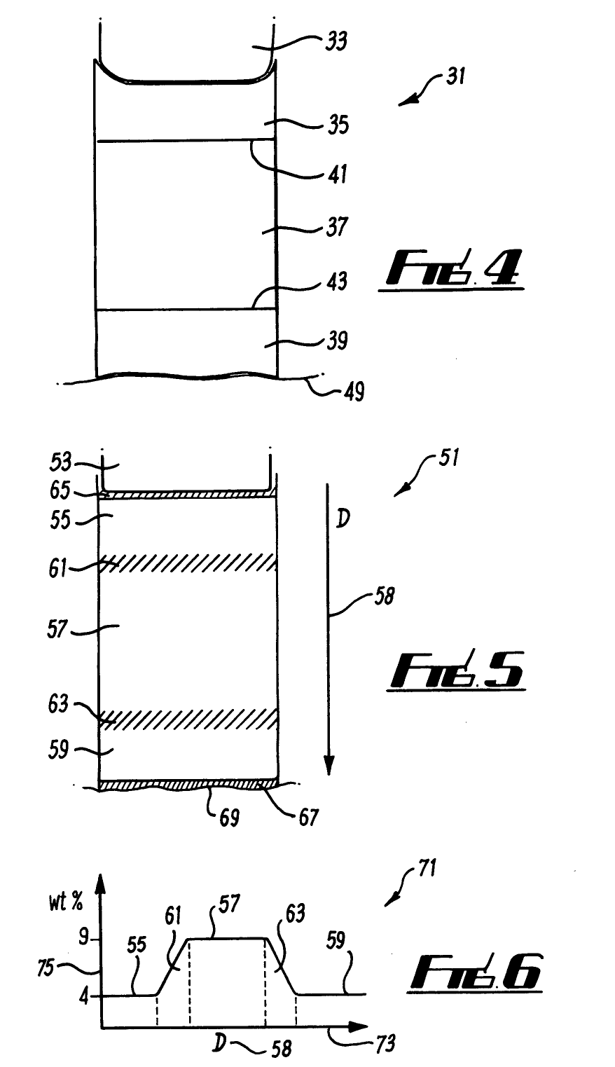

FIG. 4 shows a second embodiment 31 of an apparatus in accordance with an aspect of the present invention similar to that of FIG. 3 which is used to couple an ultrasound probe 33 to an object 49. The apparatus comprises a first coupler 35, an intermediate layer 37 and a second coupler 39. There are two interfaces, 41 and 43, positioned between the first coupler 35 and the intermediate layer 37 and between the intermediate layer 37 and the second coupler 39, respectively.

In this example the entire arrangement of the first and second couplers, 35 and 39, along with intermediate layer 37 are made from a hydro-gel. In addition, in this example, the density (as measured by the weight percent of polyvinyl alcohol (PVA)) of the first coupler 35 and the second coupler 39 are substantially identical. The density of the intermediate layer 37 is higher than that of the first coupler 35 and the second coupler 39. The intermediate layer 37 is designed to be a harder and more resilient structure in order to provide mechanical strength to the overall structure.

Couplers 35 and 39 are designed to be pliable such that they deform on contact with the probe 33 or body 49, respectively, and conform to the shape of the probe 33 or body 49.

The apparatus 31 may be designed to be disposable after a single use.

FIG. 5 shows a third embodiment of an aspect of the present invention 51. In this embodiment, a probe 53 is positioned near or at a first coupler 55 which is connected to an intermediate layer 57 and to a second coupler 59. Liquid layers 65 and 67 are formed between the probe 53 and the object 69.

Couplers 55 and 59 are designed to exude a liquid when in operative contact with the probe 53 and the object 69, respectively. The purpose of the liquid is to provide a physical coupling between the probe 53 and first coupler 55 and between the object 69 and second coupler 59. The purpose of this coupling liquid is to remove the need for applying a gel to the object surface.

The couplers 55 and 59 have composition that readily allows a liquid 65, 67, in this example water, to be exuded onto the probe 53 and object 69. The process by which a liquid is exuded in this manner is known as syneresis and the extent to which, or the amount of, liquid that is exuded is dependant upon the density of the gel.

In one respect the couplers 55 and 57 can be viewed as liquid reservoirs where the liquid 65, 67 is held in a semi-fixed state and which can be released from the reservoir during operative contact with a probe 53 and object 69. The presence of the layers of liquid 65, 67 provide a good coupling and because the gel contains a significant amount of liquid the coupling is maintained when the probe apparatus is moved across the object surface, because liquid is continuously exuded during use.

In this example the interfaces 61 and 63 between the first coupler 55 and intermediate layer 57 and the intermediate layer 57 and second coupler 59 are not discrete. This means there is a change in density as measured by a change in the weight percentage of PVA in the hydro-gel across the layer. It is believed that this type of structure is likely to occur where the apparatus is formed using the heating/Cooling cycled described below.

Arrow 58 shows the distance through the apparatus and a graph of density 75 as measured by weight percentage of the hydro-gel against distance D 73 is shown in FIG. 6. The graph clearly shows the change in density across the interface layers 61 and 63.

As outlined above, the apparatus of the present invention can be made using PVA hydro-gels in the following manner. A first mixture containing a lower concentration of PVA is added to a container where it is first frozen and then thawed until a hydro-gel is formed in the bottom of a container (usually the container is shaped like a column).

A second mixture containing a higher concentration of PVA is added to the container where it is first frozen and then thawed until a hydro-gel is formed on top of the first formed hydro-gel. During the freezing and thawing process the second, higher density, hydro-gel fuses, bonds or mixes with the first formed hydro-gel to form a continuous hydro-gel with an area of higher concentration and an area of lower concentration of PVA.

Thereafter, a third mixture is added to the container. This third mixture contains a lower concentration of PVA similar or identical to the concentration of the PVA in the first mixture. Once again, a freezing and thaw cycle is performed until a hydro-gel is formed from the mixture. As with the first and second mixtures this third mixture, upon formation of a hydro-gel is fused, bonded or mixed with the second hydro-gel to form a larger, continuous hydro-gel with a lower density similar to the density of the first hydro-gel.

In an alternative embodiment the coupling apparatus of the present invention can be made by initially carrying out the second step so as to form the high density intermediate hydro-gel layer. Thereafter the first and second steps can be carried out in order to form the lower density hydro-gel layers on different sides of the intermediate layer. It will be appreciated that the first and second steps may be carried out simultaneously in order to speed up the production process.

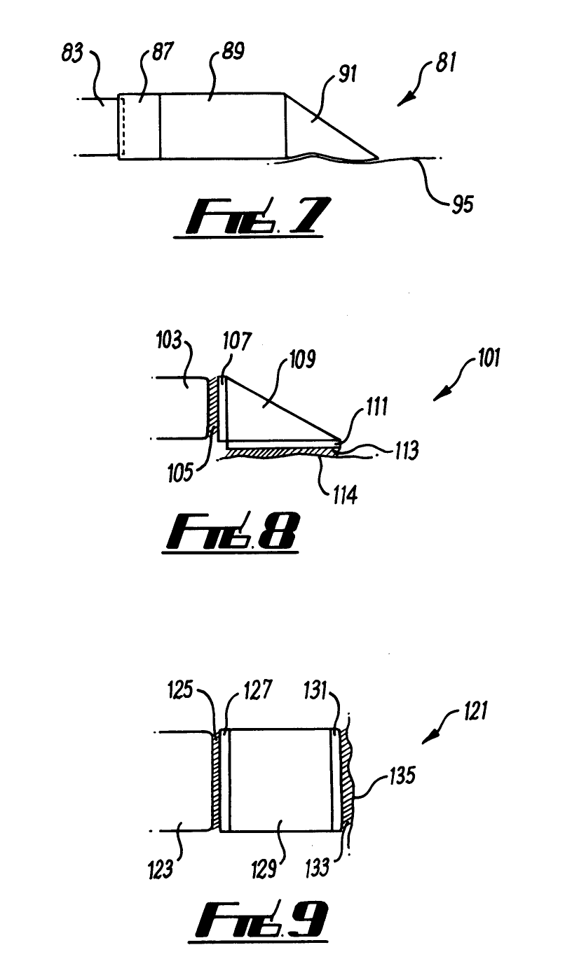

FIG. 7 shows a further embodiment of the present invention. In this example a probe 83 is coupled to an object 95 via a coupling apparatus 81 in accordance with an aspect of the present invention. The coupling apparatus 81 can be seen to comprises: a first coupler 87, an intermediate layer 89 and a second coupler 91. The first 87 and second 91 couplers are pliable and deform when a probe 83 is pressed against it or where it is pressed against a body 95. It should be noted that the embodiment of FIG. 7 has an elongated shaped and a triangular or prism shaped second coupler 91.

FIG. 8 shows another embodiment 101 of an aspect of the present invention in which the intermediate layer 109 is triangular or prism shaped and the first coupler 107 and the second coupler 111 comprise the layers of hydro-gel adapted to exude a liquid, 105 and 113, upon operative contact with a probe 103 and object 114, respectively.

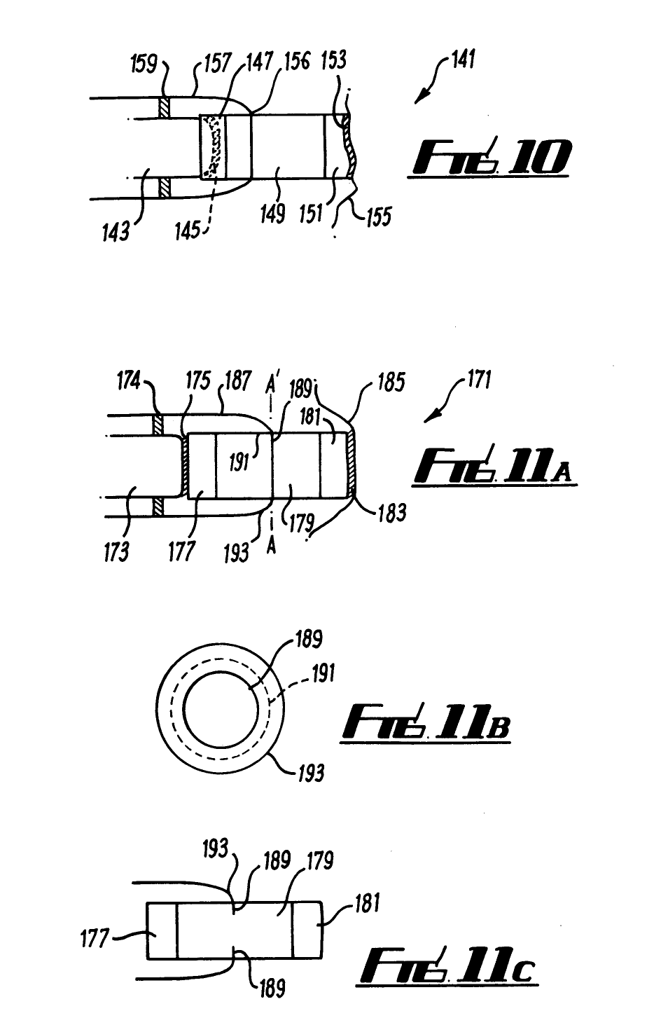

FIG. 9 shows a further embodiment 121 of an aspect of the present invention. In this embodiment the apparatus has a substantially rectangular cross section with the intermediate layer 129 forming the major part of the apparatus. The couplers 127 and 131 are relatively small when compared to the intermediate layer 129. In this case the apparatus 121 is designed to maximise the mechanical strength and structural properties that are provided by the intermediate layer 129, whilst providing a suitable amount of lower concentration hydro-gel in the couplers 127 and 131 to provide liquid layers 125 and 133 upon operative contact with a probe 123 and object 135.

FIG. 10 shows another embodiment 141 of an aspect of the present invention in which the probe 143 is adapted for use in vivo by the addition of a sheath or cover 157. FIG. 10 shows a probe 143, liquid layer 145, first coupler 147, intermediate layer 149, second coupler 151, liquid layer 153 and object 155. In addition, a sheath 157 is arranged around the probe so as to enclose the probe when in use. A frame 159 is also included to space the sheath 157 from the probe 143. The sheath 157 is attached to the intermediate layer 149. This attachment may be via an elasticated collar 156 or the like that forms a tight fit around the intermediate layer 149. In addition, the intermediate layer may be provided with a circumferential channel which is adapted to accept a leading portion of the sheath 157. In this way the edge of the sheath 157 can fit into the channel thereby improving the fit between the channel and the sheath 157.

FIGS. 11A to 11C show a further embodiment 171 of an aspect of the present invention. FIG. 11A shows the probe 173, a frame 174, a liquid layer 175, a first coupler 177, an intermediate layer 179, a second coupler 181, a liquid layer 183 and an object 185. In this embodiment of the present invention the sheath 187 is integrally formed with the intermediate layer 179 during manufacture of the apparatus 171. The position of the embedded portion 189 of the sheath 187 is clearly shown in relation to the outer surfaces 191 and 193 of the intermediate layer 179 and the sheath 187, respectively, within FIGS. 11B and 11C. In addition, FIG. 11A also show the outer surface 193 of the sheath 187 as it extends backwards towards the probe 173.

In this embodiment of an aspect of the present invention the integrated sheath 187 provides a ready made hygienic and sterile sheath which, as with the previous embodiment, that does not present any part of the sheath 157 or 187 to the path of the ultrasound as it goes from the probe, 143 or 173, to the object, 155 or 185. In addition, the embodiment of FIGS. 11A to 11C provides a sturdy and secure fixing for the sheath 187. Once the sheath, 157 or 187, and probe, 143 or 173, have been used the sheath, 157 or 187, and coupler apparatus, 141 or 171, may be disposed of hygienically. In this way, there is little or no prospect of contamination of the expensive ultrasound probe, 143 or 173.

The above described apparatus provides an improved means for coupling an ultrasound probe to an object and particularly a medical ultrasound probe to a patient. This is achieved without the need to deploy layers of gel to the object or patient or to employ hydro-gel pads. Since the described apparatus comprises a multi layered hydro-gel structure it provides an elegant and cost effective solution for improving the coupling of ultrasound to an object. In some or the above described embodiments, a sheath is employed that provides for a cost effective disposable device thus significantly reducing the risk of cross contamination between patients.

The foregoing description of the invention has been presented for purposes of illustration and description and is not intended to be exhaustive or to limit the invention to the precise form enclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A coupling apparatus for coupling an ultrasound probe to an object, the coupling apparatus comprising:
a first coupler connectable to the probe;
a second coupler connectable to the object; and
and an intermediate layer for acoustically connecting the first coupler and the second coupler, the intermediate layer being further adapted to provide structural strength to the apparatus,
wherein, the first coupler and the second coupler are adapted for direct acoustic coupling with the respective probe and object.

2. A coupling apparatus as claimed in claim 1 wherein the first and second couplers are made of a pliable material such that when in contact with the probe or the object the first or second coupler deforms to fit the shape of the probe or the object, respectively.

3. (canceled)

4. A coupling apparatus as claimed in claim 1 wherein one or both of the first and second couplers exudes an acoustic coupling liquid when in operative contact with the probe or the object, respectively.

5. (canceled)

6. (canceled)

7. A coupling apparatus as claimed in claim 1 wherein one or both of the first and second couplers is made from a material that undergoes syneresis.

8. (canceled)

9. A coupling apparatus as claimed in claim 1 wherein one or both of the first and second couplers is a gel.

10. (canceled)

11. (canceled)

12. (canceled)

13. (canceled)

14. (canceled)

15. (canceled)

16. (canceled)

17. (canceled)

18. A coupling apparatus as claimed in claim wherein the intermediate layer has a similar, or identical, acoustic impedance to the first coupler and second coupler.

19. A coupling apparatus as claimed in claim 1 wherein the intermediate layer has a higher density than the first coupler or the second coupler.

20. A coupling apparatus as claimed in claim 1 wherein the intermediate layer is a gel.

21. A coupling apparatus as claimed in claim 20 wherein the gel is a hydro-gel.

22. A coupling apparatus as claimed in claim 21 wherein the hydro-gel is a polyvinyl alcohol hydro-gel.

23. A coupling apparatus as claimed in claim 22 wherein the hydro-gel has a composition with greater than six weight percentage of polyvinyl alcohol.

24. (canceled)

25. (canceled)

26. (canceled)

27. A coupling apparatus as claimed in claim 1 wherein the intermediate layer is acoustically coupled to the first coupler and the second coupler via a junction layer defined by a transition layer of varying density.

28. A coupling apparatus as claimed in claim 27 wherein the transition layer is characterised by an increased density towards the intermediate layer.

29. (canceled)

30. (canceled)

31. (canceled)

32. (canceled)

33. (canceled)

34. (canceled)

35. (canceled)

36. A coupling apparatus as claimed in claim 1, further comprising a cover integrally formed with the intermediate layer.

37. (canceled)

38. (canceled)

39. A coupling apparatus as claimed in claim 1, further comprising a cover connectable to the coupling apparatus by means of a channel, wherein the channel is in the intermediate layer.

40. (canceled)

41. A method for making a coupling apparatus for coupling an ultrasound probe to an object, the method comprising the steps of:
applying a heating and cooling cycle to a first mixture in order to form a first hydro-gel of a first density;
adding a second mixture to the first formed hydro-gel and applying a heating and cooling cycle to the second mixture so as to form a second hydro-gel having a second density, wherein the second density is higher than the first density and
adding a third mixture and applying a heating and cooling cycle to form a third hydro-gel of a third density, wherein the third density is lower than the second density.

42. A method for making a coupling apparatus as claimed in claim 41 wherein the third density is selected so as to be equal to the first density.

43. A method for making a coupling apparatus as claimed in claim 41 wherein one or both of the first and third hydro-gels is a polyvinyl alcohol hydro-gel.

44. A method for making a coupling apparatus as claims in claim 43 wherein one or both of the first or third hydro-gels has a composition of less than six weight percentage polyvinyl alcohol.

45. (canceled)

46. (canceled)

47. A method for making a coupling apparatus as claimed in claim 41 wherein the second hydro-gel is a polyvinyl alcohol hydro-gel.

48. A method for making a coupling apparatus as claimed in claim 47 wherein the second hydro-gel has a composition of greater than six weight percentage polyvinyl alcohol.

49. A method for making a coupling apparatus for coupling an ultrasound probe to an object, the method comprising the steps of:
applying heating and cooling cycle to a first mixture in order to form a intermediate hydro-gel layer having a first density;
adding a second mixture to a first side of the intermediate hydro-gel layer and applying a heating and cooling cycle to the second mixture so as to form a first hydro-gel layer having a lower density than the intermediate hydro-gel layer; and
adding a third mixture to a second side of the intermediate hydro-gel layer and applying a heating an cooling cycle to third mixture so as to form a second hydro-gel layer having a lower density than the intermediate hydro-gel layer.

50. A method for making a coupling apparatus as claimed in claim 49 wherein the second and third steps are carried out simultaneously.
